(19) United States
(12) Patent Application Publication
(10) Pub. No.: US 2014/0086448 A1
(43) Pub. Date: Mar. 27, 2014

(54) Appearance Model Based Automatic Detection in Sensor Images

(71) Applicant: MVT EQUITY LLC D/B/A MILLIVISION, South Deerfield, MA (US)

(72) Inventor: Nitin M. Vaidya, Shrewsbury, MA (US)

(73) Assignee: MVT Equity LLC d/b/a Millivision Technologies, South Deerfield, MA (US)

(21) Appl. No.: 13/625,565

(22) Filed: Sep. 24, 2012

(51) Int. Cl. G06K 9/62

(52) U.S. Cl. 382/103

(57) ABSTRACT

Embodiments relate to appearance model based automatic detection in sensor images. In one arrangement, a detection apparatus of an Automated Threat Detection system utilizes generative, statistical models of human appearance in sensor images, such as MMW images, as a basis for comparison with images received by a sensor such as an MMW sensor. The detection apparatus can effectively replicate, through the models, the approach of human observers to provide a relatively high throughput of subjects. Additionally, by utilizing generative, statistical models as the basis for comparison against received MMW images, the detection apparatus can minimize detection errors caused by variance in body geometry, skin reflectance, and posture of the subject to maintain a relatively low rate of false alarms and a relatively high rate of detection of threats.

### BACKGROUND

Conventional Automatic Threat Detection (“ATD”) systems are configured to automatically scan people at security checkpoints. Based upon the scan, the ATD system can sense and detect objects that may be concealed on a person that can constitute a security threat.

Typically, ATD systems use one or more sensors to provide detection of objects and provide an alarm in response to detecting a potential threat. For example, certain ATD systems can include passive millimeter-wave (MMW) sensors which create one or more images of the person or subject being scanned. In a passive MMW ATD system, the MMW sensors, such as a MMW camera, images the person at one or more desired frequencies to generate one or more MMW images of the body for analysis. The MMW camera transfers the images to a computational subsystem, such as a detection device, configured to identify locations in the images which are deemed to have high likelihood of including security threats. These locations can then be conveyed to a human operator by means of overlaying markers upon corresponding pixels in visual images of the subject recorded at the same time as the MMW imagery. The operator can utilize these automatically detected threat indications to take suitable follow-up action.

### SUMMARY

FIGS. 1 and 2 illustrate an example front and rear MMW image 10, respectively, generated by a conventional ATD system. The physics of this system dictates that the image of a clothed subject free of any concealed threats would appears to be composed mostly of bright pixels, while the image of a background behind the subject appears to be composed of dark pixels. When a subject does conceal an object under his clothes, the pixels at that location would be either darker or lighter in comparison to the pixels of the surrounding parts of the subject's body.

The ability for an ATD system to distinguish potions of the images 10 that are likely to be threats from those that are likely to benign is difficult for a variety of reasons. For example, the images formed by the MMW camera can suffer from a variety of imperfections thereby making accurate detection difficult. Additionally, the appearance of benign parts of the subject's body can often mimic that of threats in the MMW imagery, which can lead to false positive identification of a threat. For example, as indicated in FIGS. 1 and 2, even threat-free parts of the human body have shades of lightness 12 and darkness 14 in the MMW imagery 10. Conventional ATD systems are not configured to determine whether some region of apparently distinctive brightness in the image 10 should be considered a benign part of the body or a true threat. By contrast, human observers of the images 10 can effectively compare the appearance of the subject in the image 10 with a mental model of a typical MMW image and judge whether a particular region defies expectation and therefore should be declared an anomaly or threat.

By contrast to conventional ATD systems, embodiments of the present innovation relate to appearance model based automatic detection in sensor images. In one arrangement, a detection apparatus of an ATD system utilizes generative, statistical models of human appearance in sensor images, such as MMW images, as a basis for comparison with images received by a sensor such as an MMW sensor. The detection apparatus can effectively replicate, through the models, the approach of the above referenced human observers to provide a relatively high throughput of subjects through the ATD system while minimizing user fatigue as well as total manpower required to monitor the ATD system. Additionally, by utilizing generative, statistical appearance models as the basis for comparison against received MMW images, the detection apparatus can minimize detection errors caused by variance in body geometry, skin reflectance, and posture of the subject to maintain a relatively low rate of false alarms (e.g., erroneous detection of benign parts of a subject's body as being a threat) and a relatively high rate of detection of threats.

In use, as the ATD system receives captured MMW images from an imaging sensor, the system invokes algorithms internal to the generative appearance model to generate synthetic MMW images that fit as closely as possible the actual captured MMW images from the scan. The system can then apply algorithms to detect a difference between the captured image and the synthetic model-generated image, indicative of the presence of an object threat carried by the subject being scanned. In one arrangement, the system can bypass regions of the resulting difference image that indicate a relatively large difference between the images for reasons other than the presence of threats. The system can further apply algorithms that estimate the extent of asymmetry in the captured image. Unexpectedly high asymmetry in the captured image can indicate the presence of an object threat. The system can then superpose an indication and location of the threat onto a display of the captured image for optional presentation to the human operator of the system.

In one arrangement, embodiments of the innovation relate to a method for detecting a presence of an object threat in a detection apparatus. The method includes receiving, by the detection apparatus, a captured image of a subject from an imaging device. The method includes receiving, by the detection apparatus, a synthetic image 114 from a generative appearance model 106 of a generative appearance model apparatus 105. The method includes comparing, by the detection apparatus, pixel data of the captured image with pixel data of the synthetic image to generate a pixel data result. The method includes detecting, by the detection apparatus, an object threat associated with the subject in response to detecting a difference between the pixel data of the captured image and the pixel data of the synthetic image.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates an MMW image of a front portion of a person using a passive MMW imaging system.

FIG. 2 illustrates an MMW image of a rear portion of a person using a passive MMW imaging system.

FIG. 3 illustrates a schematic representation of an ATD system, according to one arrangement.

FIG. 4 illustrates a schematic representation of the generative appearance model, according to one arrangement.

FIG. 5 is a flowchart that illustrates method for detecting a presence of an object threat as performed by a detection apparatus of the ATD system of FIG. 3, according to one arrangement.

FIG. 6 illustrates an example of a binary synthetic image showing a foreground image inferred using model-fitting.

FIG. 7 illustrates an example of the binary synthetic image showing a version of foreground image of FIG. 6 after boundary erosion.

FIG. 8 illustrates a first side captured image of a subject.

FIG. 9 illustrates a second side captured image of the subject of FIG. 8, the second side opposing the first side.

FIG. 10 illustrates a schematic representation of a process performed by a detection apparatus when detecting asymmetry between a pair of views, according to one arrangement.

FIG. 11 illustrates another schematic representation of the ATD system, showing a second arrangement of the flow of information between the detection apparatus and the appearance model.

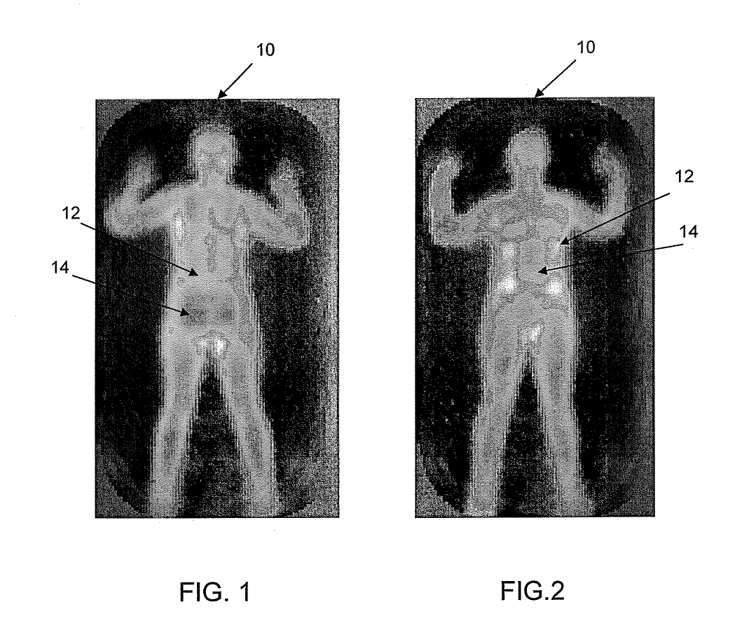

### DETAILED DESCRIPTION

Embodiments of the present innovation relate to appearance model based automatic detection in sensor images. In one arrangement, a detection apparatus of an ATD system utilizes generative, statistical models of human appearance in sensor images, such as MMW images, as a basis for comparison with captured images received by a sensor such as an MMW sensor. In use, as the ATD system receives captured MMW images from an imaging sensor, the system invokes algorithms internal to the generative appearance model to obtain synthetic MMW images that fit as closely as possible the actual captured MMW images from the scan. The system can then apply algorithms to detect a difference between the captured image and the synthetic model-generated image, indicative of the presence of an object threat carried by the subject being scanned.

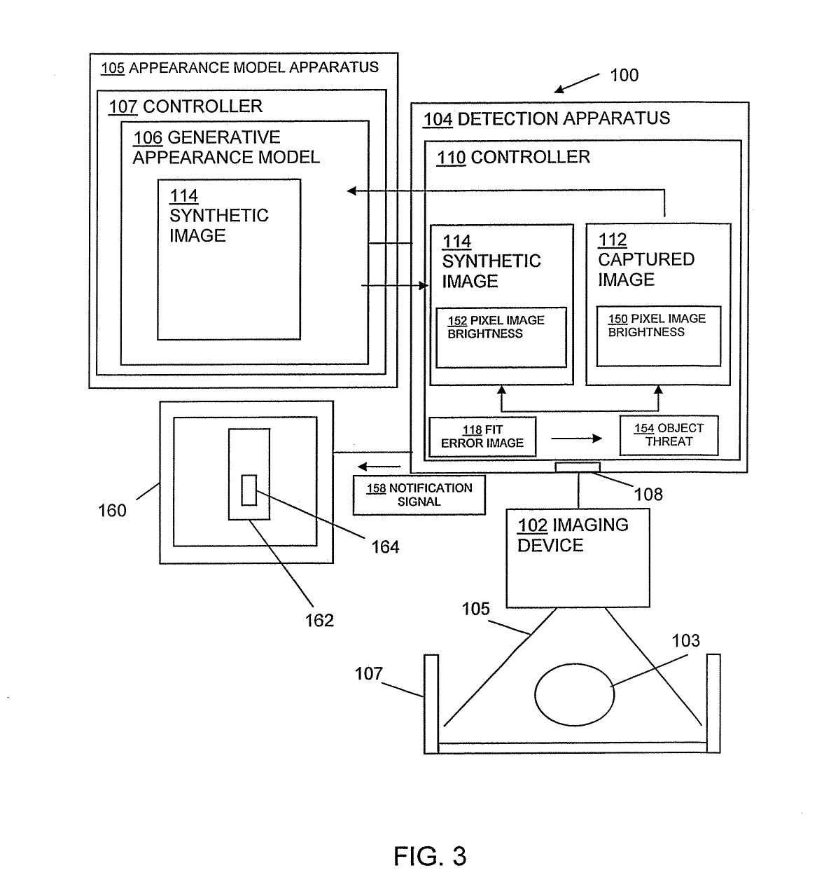

FIG. 3 illustrates an example of an Automatic Threat Detection (ATD) system 100, according to one arrangement. The system 100 includes an imaging device or sensor 102, such as a millimeter wave (MMW) camera and a detection apparatus 104 disposed in electrical communication with a generative appearance model 106. The system is configured to detect the presence of an object threat for a body or subject 103 being scanned. It should be understood that the phrase object threat can refer to any object and in particular, refers to a class of preselected objects that includes knives, weapons, explosives, and other objects that may be dangerous and prove to be a threat to other people, vehicles, buildings, or the general surroundings. It also includes objects such as wads of currency, drugs, compact discs with sensitive data and other such objects whose smuggling through check-points breaks the law.

The imaging device 102 is configured to capture an image of a subject 103 and transmit the image to the detection apparatus 104. For example, the imaging device 102 includes a field of view 105 that encompasses the subject 103 standing within an enclosure 107. The field of view 105 includes an interior of the enclosure 107 that at least partially encloses the subject 103 to reduce the effect of external MMW radiation that could be sensed by the imaging device 102 thereby either increasing the noise in the system 100 or altering the contrast in the images which can result in making false positive readings more likely.

In use, the imaging device 102 generates and provides a sequence of captured images of the subject 103 to the detection apparatus 104. For example, the subject 103 can stand within the enclosure 107 and rotate within the field of view of 105 of the imaging device 102. In this way, the subject 103 can be imaged about the entire periphery of their entire body. In another embodiment, the imaging device 102 can be affixed to a mechanism that rotates the imaging device about the subject 103 to image the entire periphery of the subject 103. The imaging device 102 generates a sequence of images (e.g., millimeter wave images) of the subject 103 as the subject 103 rotates within the field of view 105 and forwards the images as captured images to the detection apparatus 104.

The detection apparatus 104 is a computerized device having a controller 110, such as a processor and memory, configured to receive capture images from the imaging device 102 via communications port 108. As will be described in detail below, the detection apparatus 104 is configured to compare each captured image 112 with a corresponding synthetic image 114 generated by the appearance model 106. Based upon a detected difference between the captured and synthetic images 112, 114, the detection apparatus 104 is configured to detect the presence of an object threat associated with the subject 103 and provide a notification regarding the same.

The generative appearance model 106, such as executed by a controller 107 of a generative appearance model apparatus 105, is configured to generate a best-fitting synthetic image 114 with a foreground region whose shape, size, and brightness makeup can be modified across a large numbers of modes of variations or degrees of freedom. The extent to which the appearance of these synthetic images 114 can be made to vary is directly proportional to the diversity of appearance of the subjects that are used to build the model 106. Given an actual captured image 112 of a new subject, the algorithms internal to the model 106 have the ability to modify a stored reference appearance such that the geometric and brightness attributes of the modified appearance match closely those of the given captured image 112. Multiple appearance models 106 may be built, where separate models are dedicated to different views of interest (e.g. front, back, left side, right side of subjects).

When developing the appearance model 106, a developer can utilize a generative model method, such as the Active Appearance Model (AAM) technique, for creating simulated or abstracted MMW images of human subjects. During the development process, the developer can record MMW images for a relatively large set of subjects without any concealed threats to encode information of the multitudinous variations in shape, size, and MMW brightness of subjects in the population of interest. For example, the subjects utilized during development of the generative appearance model 106 can be different ages, heights, weights, and both genders, representing a cross-section of the population of interest. The developer then manually annotates each of the MMW images to specify the locations of various landmarks on the body, such as each subject's armpit, elbow, and crotch location. The images of subjects representing a cross-section of the population of interest and the locations of landmarks in these images constitute the training-set of the appearance model 106.

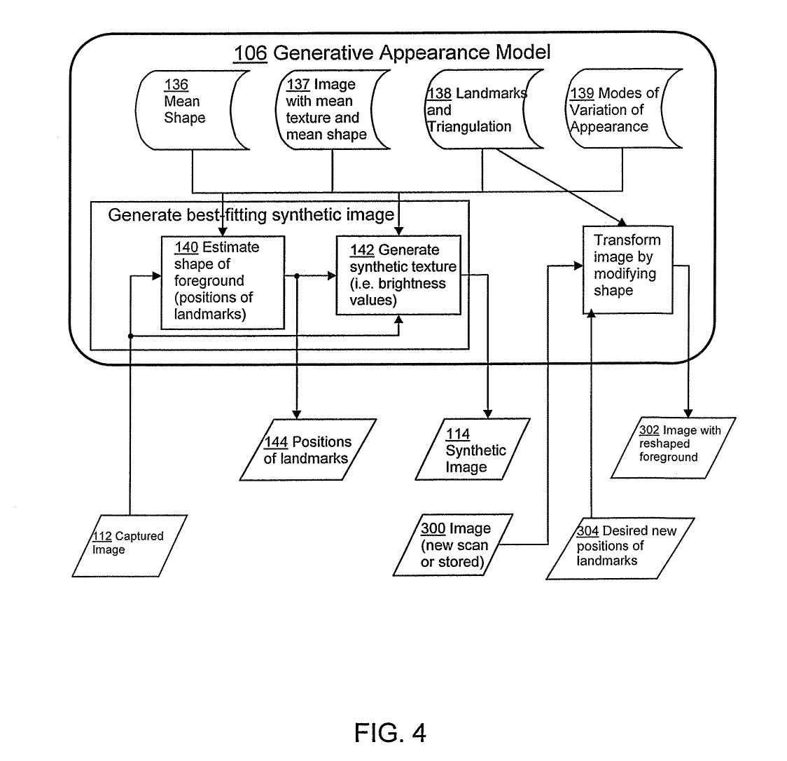

The developer can then build the appearance model 106 from the recorded MMW images and the associated annotations by utilizing algorithms innate to the framework of the chosen type of appearance model. For example, with reference to FIG. 4, the building of the appearance model typically includes the creation of arrangements of data (i.e., stored data) such as the mean shape data 136 and the mean texture image characteristic (i.e., brightness texture or brightness values) 137 of the training set of images, and annotated landmarks and triangulation data 138. Also computed are the different modes of variation 139 encountered in the shape and texture of the training set data. Accordingly, the models 106 are capable of generating synthetic images 114 that can be made to conform to the large range of appearances in the recorded MMW images.

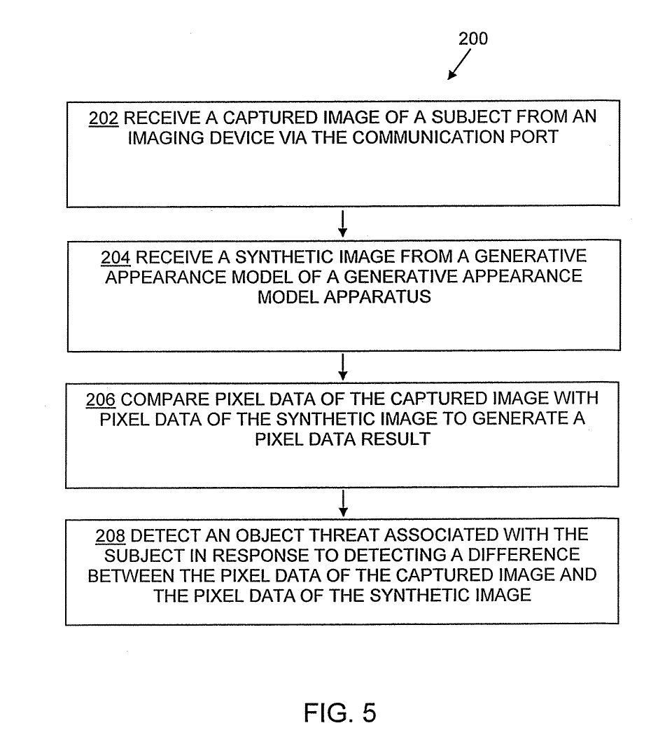

FIG. 5 is a flowchart 200 that illustrates method for detecting a presence of an object threat as performed by the detection apparatus 104 of the ATD system 100. The method substantially replicates, through operation of the detection apparatus 104, the object threat detection approach typically utilized by human observers to detect mismatches between aspects of a captured image 112 (i.e., an image having a potential object threat) and a synthetic image 114 (i.e., an image, generated using the appearance model 106, that is as close as possible to the captured image 112). Based upon the detection of the differences between the captured image 112 and the synthetic image 114, the detection apparatus 104 can determine the presence of object threats associated with the subject 103 under scrutiny. In regions with any concealed threats, a pixel brightness magnitude 152 of the synthetic image 114 typically differs from a pixel brightness magnitude 150 of the captured image 112, on account of the model 106 being purpose-built to replicate the appearance of only threat-free subjects.

In step 202, the detection apparatus 104 receives a captured image 112 of a subject 103 from an imaging device 102 via the communication port 108. For example, with reference to FIG. 3, the imaging device 102 provides the detection apparatus 104 with a sequence of captured images 112 taken of a subject 103 from multiple angles (e.g., front, side, back). As indicated, the captured image 112 includes pixel data, such as pixel image brightness data 150, also termed pixel brightness texture, herein.

Returning to FIG. 5, in step 204, the detection apparatus 104 receives a synthetic image 114 from a generative appearance model 106 of a generative appearance model apparatus 105. For example, the detection apparatus 104 forwards the captured image 112, such as a front image of a subject 103, to the generative appearance model apparatus 105 to invoke the generative functionality of the appearance model 106. In response to receiving the captured image 112, the generative appearance model apparatus 105 generates a best-fitting synthetic image 114 from the appearance model 106. For example, based upon the captured image 112 and using the stored mean shape data 136, the mean texture image characteristic data 137 of the training set of images, the annotated landmarks and triangulation data 138, and the different modes of variation encountered in the shape and texture of the training set data 139, the appearance model 106 estimates the shape of the foreground 140 of the captured image 112, makes the synthetic image 114 have this shape and generates brightness values 142 for the synthetic image 114. As a result, the appearance model 106 generates a best fitting synthetic image 114 having an associated pixel image brightness 152, as related to the captured image 112, and forwards the synthetic image 114 to the detection apparatus 104.

In one arrangement, the appearance model 106 also generates estimates of the coordinate values of the landmarks 144 in the given captured image 112. The appearance model 106 also forwards these estimates 144 to the detection apparatus 104. It should be noted that in addition to the best-fitting synthetic image 114 and estimates of the coordinates of the landmarks 144 in the captured image 112, the detection apparatus 104 also has access to the mean shape 136 and mean texture data 137 computed and stored during the building of the appearance model 106.

With reference to FIG. 5, in step 206, the detection apparatus 104 compares pixel data of the captured image 112 with pixel data of the synthetic image 114 to generate a pixel data result. In one arrangement, with reference to FIG. 3, after receiving the synthetic image 114, the detection apparatus 104 detects the difference in the pixel brightness magnitudes 150, 152 between the captured image 112 and the synthetic image 114 at corresponding image locations to generate a fit error image 118.

For example, portions of the captured image 112 that are free of any object threats are composed mostly of relatively bright pixels. Accordingly, a difference between the pixel brightness magnitude 150 across the captured image 112 and the pixel brightness magnitude 152 across the synthetic image 114 results in a fit error image 118 having relatively low fitting error values across entire body. However, when a subject 103 does conceal a threat, the pixels of the corresponding portion of the captured image 112 would be darker or lighter in comparison to the pixels of the surrounding parts of the image 112. A difference between the pixel brightness magnitude 150 across the captured image 112 and the pixel brightness magnitude 152 across the synthetic image 114 results in the fit error image 118 having relatively large fitting errors in one area of the body.

With reference to FIG. 5, in step 208, the detection apparatus 104 detects an object threat 154 associated with the subject 103 in response to detecting a difference between the pixel data of the captured image 112 and the pixel data of the synthetic image 114. For example, assume the case where the detection apparatus 104 detects a relatively large difference in pixel brightness magnitude between the pixel brightness magnitude 150 of a number of pixels in a given threshold area or cluster in the captured image 112 and the pixel brightness magnitude 152 of a number of pixels in the corresponding area or cluster in the synthetic image 152 (i.e., a relatively large fitting error in an area of the fit error image 118). In such a case, based upon the detected difference in the pixel brightness magnitudes (i.e., the relatively large fitting error in a portion of the fit error image), the detection apparatus 104 can detect an object threat 154 associated with the subject 103.

Returning to FIG. 3, in response to detecting the object threat 154, the detection apparatus 104 is configured to generate a notification signal 158 which identifies the presence of the object threat 154 associated with the captured image 112 and provides the system operator with the opportunity to intervene with the subject 103. In one arrangement, the detection apparatus 104 can provide the notification signal by way of a monitor or display 160. For example, the detection apparatus 104 can provide a visual representation 162 of the captured image 112 to the display 160. While the visual representation 162 can be configured in a variety of ways, in one arrangement, the visual representation 162 is an image of a generic human figure to safeguard the privacy of the subject 103.

In one arrangement, the detection apparatus 104 provides, as the notification signal 158, a visual indicator 164 superimposed on the visual representation 162 of the captured image 112 at the detected location of the object threat 154. For example, the detection apparatus 104 identifies landmarks associated with the synthetic image 114 and the captured image 112 to map the coordinates of the detected object threat 154 onto the coordinates of the common generic visual representation 162. The detection apparatus 104 can superimpose the visual indicator 164 of the candidate threat regions identified onto the gray-tone visual representation 162 in an eye-catching color for purposes of validation to a human evaluator.

Accordingly, as indicated above, the detection apparatus 104 can effectively replicate the approach of the conventional human observers to detect differences in pixel image brightness 150 of a captured image 112 of a subject 103 and pixel image brightness 152 in a corresponding synthetic image 114 to provide a relatively high throughput of subjects through the ATD system 100. The configuration of the detection apparatus 104, therefore, minimizes operator fatigue as well as the total manpower required to monitor the system 100. Additionally, by utilizing generative, statistical models as the basis for comparison against the captured images 112, the detection apparatus 104 can minimize detection errors caused by variance in body geometry, skin reflectance, and posture of the subject to maintain a relatively low rate of false alarms (e.g., erroneous detection of benign parts of a subject's body as being a threat) and a relatively high rate of detection of object threats 154.

While the detection apparatus 104 is configured to maintain a relatively low rate of false alarms, the detection apparatus 104 can be configured to further minimize the risk of false alarms while maximizing object threat detections. For example, when comparing the pixel image brightness 150 of the captured image 112 with the pixel image brightness 152 of the synthetic image 114, the detection apparatus 104 can be configured to bypass regions of the corresponding images 112, 114 that are likely to have a large difference pixel brightness magnitude for reasons other than the presence of object threats.

In one arrangement, the detection apparatus 104 is configured to bypass regions at the foreground-background border of the fit error image 118 to minimize generation of false alarms. For example, the fit error associated with the fit error image 118 is, generally, relatively high at locations in proximity to the foreground-background boundary of the fit error image 118. To minimize the risk of false alarms in the vicinity of the foreground-background boundary, the detection apparatus 104 is configured to discount the model-matching fit-error values in a narrow zone adjoining the foreground-background boundary of the fit error image 118.

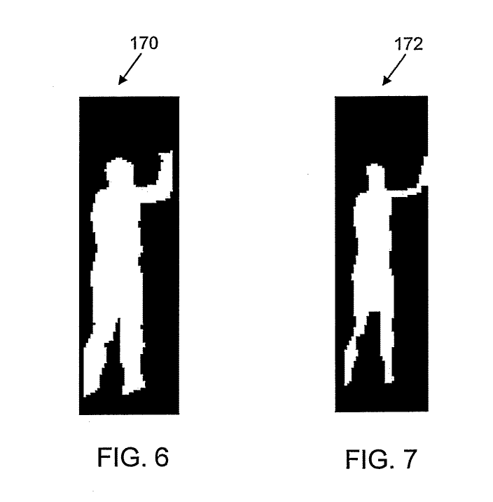

For example, once the detection apparatus 104 has generated the fit error image 118 as a difference in the pixel image brightness of the captured image and a pixel image brightness of the synthetic image, the detection apparatus 104 generates a binary image 170, such as illustrated in FIG. 6. The binary image 170 indicates the foreground of the fit-error image 118 wherever the brightness of the synthetic image 114 is above zero. The detection apparatus 104 then performs a morphological erosion of the estimated foreground of the binary image 170 to generate a boundary eroded foreground binary image 172 as illustrated in FIG. 7. The detection apparatus 104 can then utilize the boundary eroded foreground binary image 172 to detect an object threat 154 associated with the subject 103. For example, the detection apparatus 104 can multiply the fit error image 118 with the boundary eroded foreground binary image 172 to generate a boundary eroded fit error image. The detection apparatus 104 can then detect the presence of an object threat 154 when the boundary eroded fit error image indicates high fit error magnitude, such as when the boundary eroded image 172 has a relatively large fitting error within an area (i.e., the eroded version of the foreground) of the fit error image 118.

While such a configuration of the detection apparatus 104 can bring about a drastic reduction in false alarms, it does so at the cost of only a modest increase in misses of true threats close to the foreground-background boundary. Many threats of interest have dimensions larger than the narrow width of the zone eroded in the binary image 170, so their detection is not impaired by the above-described configuration of the detection apparatus 104.

As indicated above, the detection apparatus 104 is configured to detect object threats based upon a comparison of pixel image brightness data of a captured image 112 with pixel image brightness data of a synthetic image 114. In one arrangement, the detection apparatus 104 is configured to detect the presence of an object threat associated with a subject 103 based upon a comparison of the symmetry of two opposing captured images of the subject 103.

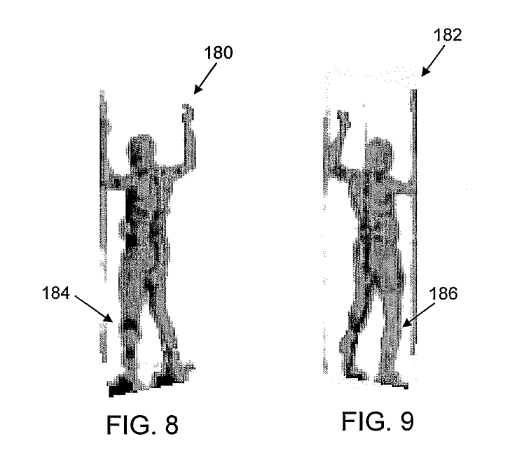

For example, as illustrated in FIGS. 8 and 9, the detection apparatus 104 can receive captured image views of a subject 103 taken from multiple angles or orientations that can be grouped in pairs having symmetrical looking directions. FIG. 8 illustrates a first side captured image 180 of a subject 103 while FIG. 9 illustrates a second side captured image 182 of the subject where the second side image 182 opposes the first side image 180. Unexpectedly high asymmetry in the captured images can indicate the presence of object threats associated with the subject. For example, if a patch 184 of the foreground of one view 180 appears too different from the symmetrically located patch 186 on the other side of the body in the corresponding view 182 of the pair, it is likely that one of the patches is the site of a concealed object.

In one arrangement, the system 100 is configured to detect asymmetry between a pair of views 180, 182.

In order to provide for detection of unexpectedly high asymmetry between views, off-line computations must first be performed to form an estimate of the ordinarily expected level of asymmetry in the training set of divested subjects used to build the generative appearance model 106. For example, a certain level of asymmetry naturally occurs in images of divested subjects. Reasons for this include subjects not placing their feet precisely at the prescribed position, not holding up both arms identically, and the innate lop-sidedness of posture of some. By forming a spatial map of the normally expected asymmetry by characterizing the differences in the left-oriented and right-oriented views in the training set of images, the detection apparatus 104 can utilize the spatial map to detect unexpectedly high asymmetry between first and second captured images 180, 182 of a subject.

In one arrangement, the developer of the detection apparatus manually identifies a correspondence between landmarks of a left-oriented and right-oriented view in the training set of images of the appearance model 106. For example, the developer records an index number of the left armpit landmark in the left-oriented view with that of a right armpit in the right-oriented view. The correspondence between landmarks implies a correspondence between the triangular patches of a tessellation of the two views. The developer uses the correspondence to laterally reflect and warp each triangular patch in the left-oriented view such that its geometry becomes that of the corresponding triangle in the right-oriented view. The cumulative result is to transform the entire left-oriented view Lᵢ of the i^{th} subject in the training set so that is spatially co-registered with the right-oriented view of that subject and creates transformed image Lᵢ*.

The developer next calculates an absolute difference image Dᵢ between the right-oriented view and the above transformed version of the left-oriented view (Dᵢ=|R−Lᵢ*|). The image Dᵢ conveys a measure of the asymmetry in brightness at different points on the views of the i^{th} subject. The operator invokes the shape-modification functionality of the right-oriented appearance model to transform the image Dᵢ to a new image Dᵢ* such that its foreground shape is warped to be the mean shape of the right-oriented views. The developer calculates Aₘₐₓ and A_{avg} 202 as images that convey the pixel-wise maximum and average of the difference images D₁*, D₂*, . . . , Dₙ* of the n subjects in the training set. These are two different pixel-wise measures of the level of expected asymmetry that was observed across the training set between the left and right oriented images.

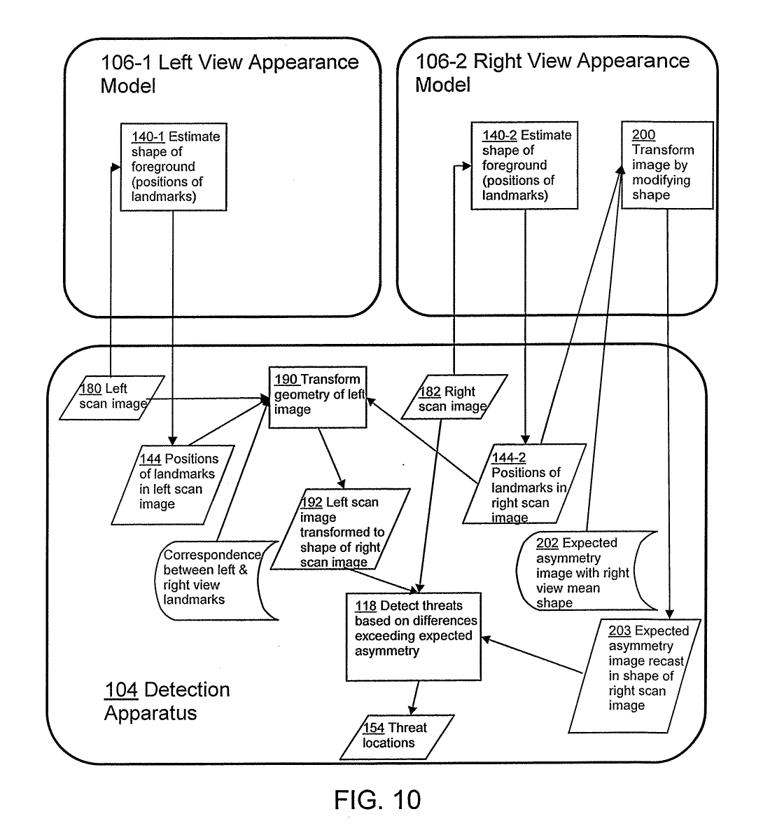

With the expected amount of asymmetry across the training set being known and with reference to FIG. 10, the detection apparatus 104 can utilize the known asymmetry to infer whether it is exceeded by the extent of asymmetry in the captured images 112 received by the detection apparatus 104.

With reference to FIG. 10, when the detection apparatus 106 receives a first side or left captured image 180 and a second side or right captured image 182 of a subject 103 (i.e., with the second side image opposing the first side image), the detection apparatus 106 is configured to invoke the fitting functionality of the left view appearance model and the right view appearance model 106-1, 106-2, respectively. For example, the detection apparatus 106 forwards the left and right captured images 180, 182 to the corresponding right and left view appearance models 106-1, 106-2. The appearance models 106-1, 106-2 then estimate the positions of all the landmarks 140-1, 140-2 of the corresponding left and right captured images 180, 182 and provide listings 144-1, 144-2 of the positions of all the landmarks in the corresponding images 180, 182.

The detection apparatus 106 next performs a transformation to transform 190 the geometry of the left captured image 180 to that of the right captured image 182. The detection apparatus 106 utilizes the listings 144-1, 144-2 of the positions of all the landmarks in the corresponding images 180, 182 to create a transformed image L* 192. The detection apparatus 106 then takes the absolute difference between the right captured image 182 and the transformed version of the left captured image 192 to generate a difference image, D (i.e., D=|R−L*|). The resulting difference image is a measure of asymmetry. The detection apparatus 106 next invokes the shape-modification functionality 200 of the right view appearance model 106-2 to transform the expected asymmetry image 202, A, such that its foreground shape is warped from the mean shape of the right-oriented views to the shape in the captured right-oriented image 182. The expected asymmetry transformed image 203 is denoted A*. The detection apparatus 106 then generates an asymmetry image C as the difference between the difference image, D, and the expected asymmetry transformed image, A* (i.e., C=D−A*), and sets negative values of the asymmetry image C to zero. The result conveys the level by which the asymmetry in the captured pair of images 180, 182 exceeds the expected level asymmetry between these views.

The detection apparatus 106 next forms a binary image B by setting to value 1 the pixels whose value in the asymmetry image C exceeds τ (i.e., where the brightness value τ indicating a threshold of significance in brightness asymmetry). The detection apparatus 106 then performs morphological filtering of image B by setting to value 0 those of its connected components whose size is below ν pixels (i.e., where the number of pixels ν indicates a threshold of significance for the size of regions of significant brightness asymmetry). For the case where discrete agglomerations of anomalous pixels having an area that exceeds a significance threshold, the detection apparatus 106 regards these cases as candidate threats 154.

While various embodiments of the innovation have been particularly shown and described, it will be understood by those skilled in the art that various changes in form and details may be made therein without departing from the spirit and scope of the innovation as defined by the appended claims.

As indicated above with respect to FIG. 4, the generative appearance model 106 is configured to generate synthetic images 114 in response to receiving captured images 112. In one arrangement, and with continued reference to FIG. 4, the generative appearance model 106 is configured to provide additional functionality, such as the estimation of the shape of the foreground of any new image 300 and the transformation of an captured image 112 such that the foreground of the image 112 is reshaped 302 to conform to any specified new shape 304. In one arrangement, the functionality to estimate foreground shape can be invoked without running the entirety of the synthetic image generation processing block.

While FIG. 4 illustrates a use of a generative appearance model 106 for generating synthetic images 114 for facilitating ATD, such illustration is by way of example only. In certain cases, are occasions where captured or scan images 112 of a subject 103 concealing a threat, that can lead to the generation of corresponding synthetic images 114 that achieve a close fit with the captured images 112, despite the presence of the threat. For example, for a synthetic image 114 provided by the generative appearance model apparatus 105, the detection apparatus may not detect an appreciable fit error 118 in the vicinity of the concealed object.

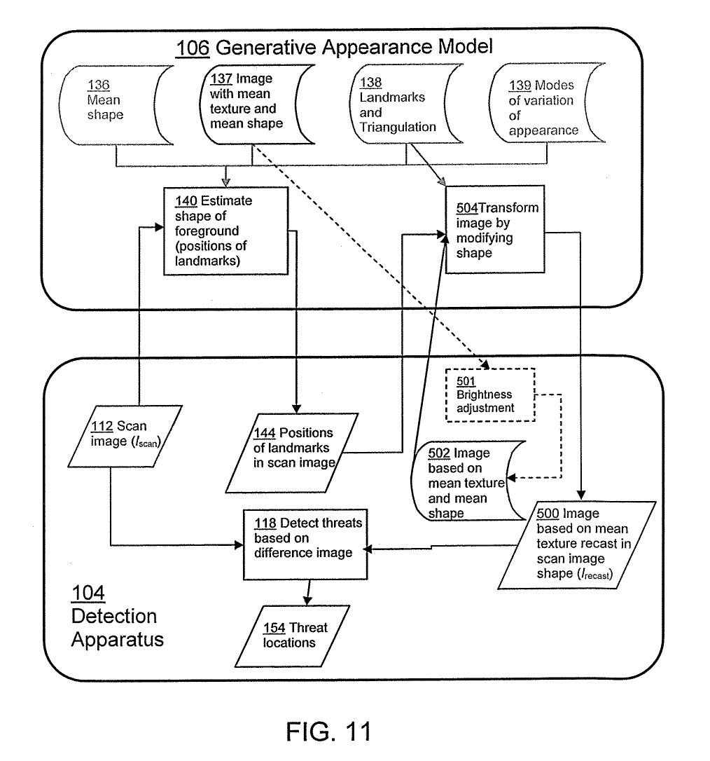

To enhance detection of a fit error between the captured image 112 and a synthetic image, in one arrangement, the generative appearance model 105 is configured to construct a synthetic image 500 having a foreground shape that is of the captured image 112 and having a texture (i.e., pixel brightness texture) based on a stored image, such as an image having a mean texture and mean shape computed during the building of the appearance model 106. FIG. 11 depicts generation of such a synthetic image 500.

Initially, the detection apparatus 104 retrieves an image with mean texture and mean shape 137 resident in the generative appearance model 106 and adjusts the brightness 501 of the image 137, such as by scaling and clipping. The detection apparatus 104 stores the resulting, processed image 502 for use in the processing subsequently received captured images 112.

When the detection apparatus 104 receives a captured image 112, I_{scan} the detection apparatus 104 forwards the captured image 112 to the generative appearance model 106, which in turn, estimates the shape the foreground 140 of the image 112. The generative appearance model 106 then uses appearance model functionality to transform 504 the aforementioned stored, processed image 502 to conform the image 502 to the foreground shape of the current captured image 112, I_{scan}. The resulting synthetic image 500, I_{recast}, is a model-based synthetic image having a shape that substantially matches the shape of synthetic image 500, I_{recast}, but having differing textures. The detection apparatus 104 utilizes the difference between I_{recast} 500 and I_{scan} 112 as the basis for identifying threats. For example, the images 112, 500 can substantially differ in brightness in the vicinity of a concealed threat. As a consequence, higher rates of detection can result from the method of FIG. 11.

What is claimed is:

1. In a detection apparatus, a method for detecting a presence of an object threat, comprising:
receiving, by the detection apparatus, a captured image of a subject from an imaging device;
receiving, by the detection apparatus, a synthetic image from a generative appearance model of a generative appearance model apparatus;
comparing, by the detection apparatus, pixel data of the captured image with pixel data of the synthetic image to generate a pixel data result; and
detecting, by the detection apparatus, an object threat associated with the subject in response to detecting a difference between the pixel data of the captured image and the pixel data of the synthetic image.

2. The method of claim 1, wherein the pixel data of the captured image comprises a pixel image brightness of the captured image and the pixel data of the synthetic image comprises a pixel image brightness of the synthetic image.

3. The method of claim 1, wherein receiving the synthetic image from the generative appearance model of the generative appearance model apparatus comprises:
transmitting, by the detection apparatus, the captured image to the generative appearance model to generate a best-fit synthetic image; and
receiving, by the detection apparatus, the best-fit synthetic image from the generative appearance model, the best-fit synthetic image having an estimate of foreground shape and brightness values based upon mean shape data, mean texture data, landmark data, and modes of variation of appearance data associated with the generative appearance model.

4. The method of claim 1, wherein:
comparing pixel data of the captured image with pixel data of the synthetic image comprises comparing, by the detection apparatus, a pixel brightness magnitude of at least a portion of the captured image with a pixel brightness magnitude of at least a portion of the synthetic image; and
detecting the object threat associated with the subject comprises detecting, by the detection apparatus, the object threat associated with the subject in response to detecting a difference between the pixel brightness magnitude of the captured image and the pixel brightness magnitude of the synthetic image.

5. The method of claim 1, further comprising, in response to detecting the object threat associated with the subject, outputting, by the detection apparatus, a notification signal identifying the presence of the object threat.

6. The method of claim 5, wherein outputting the notification signal identifying the presence of the object threat in the captured image comprises:
outputting, by the detection apparatus, a visual representation of the captured image; and
superimposing, by the detection apparatus, a visual indicator on the visual representation of the captured image, the visual indication identifying a location of the object threat in the captured image.

7. The method of claim 1, wherein:
comparing pixel data of the captured image with pixel data of the synthetic image comprises:
generating, by the detection apparatus, a fit error image as a difference in the pixel image brightness of the captured image and a pixel image brightness of the synthetic image,
generating, by the detection apparatus, a binary image indicating a foreground of the fit error image wherever a pixel image brightness of the synthetic image is greater than zero, and
eroding, by the detection apparatus, a boundary between a foreground portion of the binary image and a background portion of the binary image to generate a boundary eroded foreground binary image; and
multiplying, by the detection apparatus, the fit error image with the boundary eroded foreground binary image to generate a boundary eroded fit error image; and
detecting the object threat in the captured image comprises detecting, by the detection apparatus, the object threat in the captured image and associated with the subject when the boundary eroded fit error image indicates high fit error magnitude.

8. The method of claim 1, wherein:
receiving the synthetic image from the generative appearance model of the generative appearance model apparatus comprises receiving, by the detection apparatus, the synthetic image having a foreground shape associated with the captured image and a pixel brightness texture associated with a stored image associated with the generative appearance model; and
detecting the object threat associated with the subject in response to detecting a difference between the pixel data of the captured image and the pixel data of the synthetic image comprises detecting, by the detection apparatus, the object threat associated with the subject in response to detecting a difference between a pixel brightness texture of the captured image and a pixel brightness texture of the synthetic image.

9. The method of claim 1, further comprising:
receiving, by the detection apparatus, a first side captured image and a second side captured image, the first side captured image opposing the second side captured image;
generating, by the detection apparatus, a transformed image by transforming a geometry of the first side captured image to that of the second side captured image;
generating, by the detection apparatus, an asymmetry image as a difference between an expected asymmetry image and the second side captured image; and
detecting, by the detection apparatus, an object threat associated with the subject in response to detecting the asymmetry image as having discrete agglomerations of anomalous pixels in regions with size values greater than a size value threshold.

10. A detection apparatus, comprising:
a communication port configured to receive captured images; and
a controller disposed in electrical communication with the communication port, the controller configured to:
receive a captured image from an imaging device of a subject via the communication port;
receive a synthetic image from a generative appearance model of a generative appearance model apparatus;
compare pixel data of the captured image with pixel data of the synthetic image to generate a pixel data result; and
detect an object threat associated with the subject in response to detecting a difference between the pixel data of the captured image and the pixel data of the synthetic image.

11. The detection apparatus of claim 10, wherein the pixel data of the captured image comprises a pixel image brightness of the captured image and the pixel data of the synthetic image comprises a pixel image brightness of the synthetic image.

12. The detection apparatus of claim 10, wherein when receiving the synthetic image from the generative appearance model of the generative appearance model apparatus, the detection apparatus is configured to:
transmit the captured image to the generative appearance model to generate a best-fit synthetic image; and
receive the best-fit synthetic image from the generative appearance model, the best-fit synthetic image having an estimate of foreground shape and brightness values based upon mean shape data, mean texture data, landmark data, and modes of variation of appearance data associated with the generative appearance model.

13. The detection apparatus of claim 10, wherein:
when comparing pixel data of the captured image with pixel data of the synthetic image, the detection apparatus is configured to compare a pixel brightness magnitude of at least a portion of the captured image with a pixel brightness magnitude of at least a portion of the synthetic image; and
when detecting the object threat associated with the subject, the detection apparatus is configured to detect the object threat associated with the subject in response to detecting a difference between the pixel brightness magnitude of the captured image and the pixel brightness magnitude of the synthetic image.

14. The detection apparatus of claim 10, wherein in response to detecting the object threat associated with the subject, the detection apparatus is configured to output a notification signal identifying the presence of the object threat associated with the subject.

15. The detection apparatus of claim 14, wherein when outputting the notification signal identifying the presence of the object threat in the captured image, the detection apparatus is configured to:
output a visual representation of the captured image; and
superimpose a visual indicator on the visual representation of the captured image, the visual indication identifying a location of the object threat in the captured image.

16. The detection apparatus of claim 10, wherein:
when comparing pixel data of the captured image with pixel data of the synthetic image, the detection apparatus is configured to:
generate a fit error image as a difference in the pixel image brightness of the captured image and a pixel image brightness of the synthetic image,
generate a binary image indicating a foreground of the fit error image wherever a pixel image brightness of the synthetic image is greater than zero, and
erode a boundary between a foreground portion of the binary image and a background portion of the binary image to generate a boundary eroded foreground binary image; and
multiply the fit error image with the boundary eroded foreground binary image to generate a boundary eroded fit error image; and
when detecting the object threat in the captured image detect the object threat in the captured image and associated with the subject when the boundary eroded fit error image indicates high fit error magnitude.

17. The detection apparatus of claim 10, wherein the detection apparatus is further configured to:
when receiving the synthetic image from the generative appearance model of the generative appearance model apparatus, receive the synthetic image having a foreground shape associated with the captured image and a pixel brightness texture associated with a stored image associated with the generative appearance model; and
when detecting the object threat associated with the subject in response to detecting a difference between the pixel data of the captured image and the pixel data of the synthetic image, detect the object threat associated with the subject in response to detecting a difference between a pixel brightness texture of the captured image and a pixel brightness texture of the synthetic image.

18. The detection apparatus of claim 10, wherein the detection apparatus is further configured to:
receive a first side captured image and a second side captured image, the first side captured image opposing the second side captured image;
generate a transformed image by transforming a geometry of the first side captured image to that of the second side captured image;
generate an asymmetry image as a difference between an expected asymmetry image and the second side captured image; and
detect an object threat associated with the subject in response to detecting the asymmetry image having discrete agglomerations of anomalous pixels in regions with size values greater than a size value threshold.

19. The detection apparatus of claim 10, wherein the communication port is configured to receive captured millimeter wave images.

20. In a detection apparatus, a method for detecting a presence of an object threat, comprising:
receiving, by the detection apparatus, a first side captured image and a second side captured image, the first side captured image opposing the second side captured image;
generating, by the detection apparatus, a transformed image by transforming a geometry of the first side captured image to that of the second side captured image;
generating, by the detection apparatus, an asymmetry image as a difference between an expected asymmetry image and the second side captured image; and
detecting, by the detection apparatus, an object threat associated with the subject in response to detecting the asymmetry image as having discrete agglomerations of anomalous pixels in regions with size values greater than a size value threshold.

21. A detection apparatus, comprising:
a communication port configured to receive captured images; and
a controller disposed in electrical communication with the communication port, the controller configured to:
receive a first side captured image and a second side captured image, the first side captured image opposing the second side captured image;
generate a transformed image by transforming a geometry of the first side captured image to that of the second side captured image;
generate an asymmetry image as a difference between an expected asymmetry image and the second side captured image; and
detect an object threat associated with the subject in response to detecting the asymmetry image having discrete agglomerations of anomalous pixels in regions with size values greater than a size value threshold.
